(19) United States
(12) Patent Application Publication
(10) Pub. No.: US 2015/0012451 A1
(43) Pub. Date: Jan. 8, 2015

(54) SOCIAL NETWORK PRESTIGE PROGRAM

(71) Applicant: Scala Hosting LLC, Euless, TX (US)

(72) Inventor: Hristo Todorov Rusev, Sofia (BG)

(21) Appl. No.: 14/491,859

(22) Filed: Sep. 19, 2014

Related U.S. Application Data
(63) Continuation-in-part of application No. 13/795,427, filed on Mar. 12, 2013.

(51) Int. Cl. G06Q 40/00; G06Q 50/00

(52) U.S. Cl. CPC G06Q 40/00; G06Q 50/01
USPC 705/319

(57) ABSTRACT

The disclosure generally describes computer-implemented methods, software, and systems for managing a prestige status of a user in a social network platform, with the prestige status being determined using linked possessions from one or more financial parties. One example method includes providing a visualization on a social network platform, the social network platform communicably linked to a financial platform; receiving, from the financial platform, a request to change a status of a user of the social network based on possessions of the user associated with a financial institution; and updating the visualization to reflect the user's status.

### BACKGROUND

Online social network platforms provide social network service for people to interact with each other over a computer network, e.g., the Internet, and create online communities whose members often share common interests, hobbies, backgrounds, etc. Social network services may be web-based and provide various ways for users to interact, such as chat, messaging, email, video, voice chat, file sharing, blogging, discussion groups, and so on. Social network services may contain directories of categories (e.g., former classmates) and tools to enable users to connect with friends and colleagues. Some example social network services include MySpace, Facebook, and VKontakte.

### SUMMARY

The disclosure generally describes computer-implemented methods, software, and systems for linking possessions of a user of a social network platform with a status of the user in the social network platform. One example method includes providing a visualization on a social network platform, the social network platform communicably linked to a financial platform; receiving, from the financial platform, a request to change a status of a user of the social network based on possessions of the user associated with a financial institution; and updating the visualization to reflect the user's status.

The details of one or more implementations of the subject matter of the present disclosure are set forth in the accompanying drawings and the description below. Other features, objects, and advantages of the subject matter will be apparent from the description, the drawings, and the claims.

### DESCRIPTION OF DRAWINGS

FIG. 1 is a schematic diagram illustrating an example system with integrated social network platform and financial platform.

FIGS. 2-4 are flowcharts illustrating example processes for providing a prestige program that links possessions of a user of a social network platform with a status of the user in the social network platform.

FIGS. 5-7 are screenshots of example user interfaces for a prestige program.

### DETAILED DESCRIPTION

The present disclosure relates to computer-implemented methods, non-transitory computer-readable media, and computer systems for linking possessions of a user of a social network platform (SNP) with a status of the user in the SNP.

In some aspects, a prestige program linking user's possessions with a status of the user in the SNP is disclosed. For example, the electronic possession information can include an amount of the user's funds deposited in a bank account, a property or merchandise (e.g., luxury car, house) that the user owns or purchased from a manufacturer or a merchant, a donation provided to a charity organization or deposited in a charity account, a purchase or service history recorded in a service provider, or any other information indicating the user's belongings at a registered financial institution of the prestige program. The prestige program can apply a form of “social stratification” inside the social networks, for example, based on the user's possessions associated with a financial institution.

In some examples, the prestige program can provide a visualization that can reflect the user's status and be visible to the user as well as other users of the SNP. The status and the visualization can indicate a user's prestige, financial condition, assets, or any other appropriate information of the user in real life. Various accessibilities and functionalities can be defined and provided to the users with different statuses. In some instances, a user with a higher status may have higher prestige and better accessibilities and functionalities in the SNP than other users with none or lower statuses.

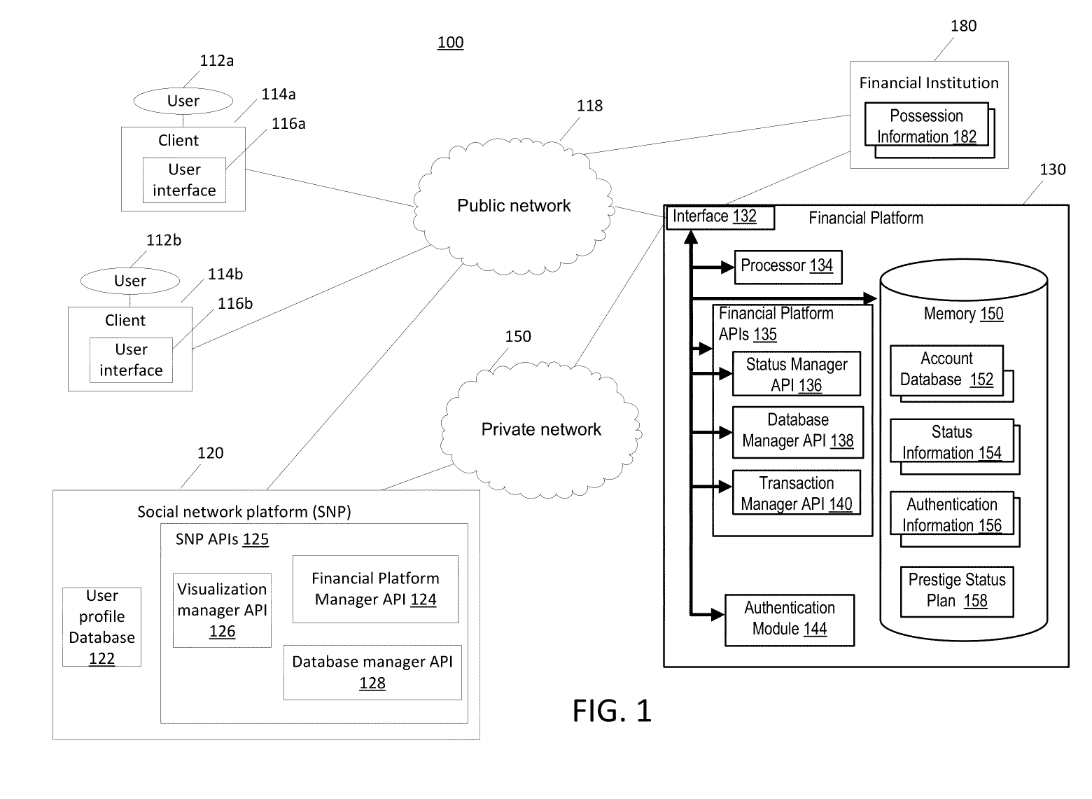

Some example techniques for providing the prestige program include selecting one or more financial institutions as partners of the SNP for the prestige program; and integrating the SNP with a financial platform that is communicably linked to the financial institution. The financial platform can coordinate with the SNP and the financial institution for linking the user's possessions associated with the financial institution with the user's status in the SNP. In some implementations, the prestige program can include a status plan with multiple statuses and their respective criteria. In some implementations, the prestige status plan (e.g., prestige status plan 158 in FIG. 1) is a data structure or other electronic rule set that includes multiple prestige statuses and criteria for each of the multiple prestige statuses that can be read, stored, or otherwise operated on from a database (e.g., memory 150) by, for example, one or more processors (e.g., processor 134) of a financial platform (e.g., financial platform 130).

As such, the prestige program can link user's possession information with a visual status of the user in the SNP to indicate a user's prestige, financial condition, assets, or other more generalized metric in real life. For example, the status of the prestige program is used to indicate a user's meritorious or positive status, such as, wealthy, financial stability, and kind-heartedness, so as to impress or attract a potential business or life partner. In some instances, at least one of the criteria identifies possessions required to qualify for the respective prestige status.

The multiple statuses and criteria for each of the statuses can be defined by the financial platform, rather than being defined or personalized by an individual user. For example, for each of the statuses, all participants of the prestige program can be evaluated based on the same criteria corresponding to the particular status, so that the prestige program can establish an objective “social stratification” inside the social networks. In addition, multiple users may share the same status and the multiple users can form a group. Different groups can be defined within the SNP, for example, based on different statuses of the prestige program.

The user of the SNP may request access to the prestige program and select an approach (e.g., a transaction) to achieve a desired status. As an example, the user may conduct a transaction with the financial institution. The financial institution may send a transaction confirmation to the financial platform which may check the user's possessions associated with the financial institution, and determine whether the criteria of the desired status are satisfied. If the criteria are satisfied, the financial platform can send a request to the SNP to update the user's status. Based on the update request, the SNP can add or modify the user's visualization to reflect the desired status. The user can also be provided with corresponding extended accessibilities and functionalities. Additional or different processes, features, or functionalities can be provided by the prestige program.

In some implementations, the prestige program and the techniques described here can provide one or more advantages. In some instances, the prestige program and the techniques can help increase the deposit base, client base, and financial condition of a financial institute or other institution (e.g., a bank, a merchant, a service provider, a charity organization, etc.). As an example, the possession information can include an amount of user's possessions at a financial institution and a duration that the user has had the amount of possessions at the financial institution, which can help drive or keep business. In some instances, the prestige program and the techniques can help the SNP attract more users and earn extra incomes from the financial institution, for example, in the form of interest rate spread related to a yield curve or a flat fee. In some instances, the prestige program and the techniques may provide users of the SNP with better services and user experience, and more effective interactions (such as networking, dating, etc.) with other users of the SNP. Any combination of these or other advantages may be achieved.

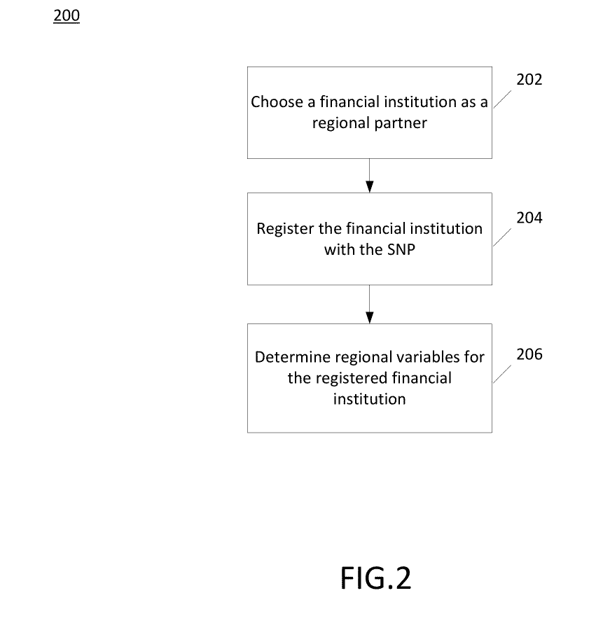

FIG. 1 is a block diagram illustrating an example system or environment 100 for integrating a social network platform with a financial platform. Generally, system 100 computer systems and software implement algorithms and other operations for managing an electronic social network prestige program. Specifically, the illustrated system 100 includes, or is communicably coupled with, a social network platform (SNP) 120, a financial platform 130, a financial institution 180, and one or more users, e.g., 112a or 112b (collectively referred to as “users 112”). The illustrated system 100 also includes clients 114a and 114b, which can be accessed and controlled by users 112a and 112b, for example, via user interfaces 116a and 116b, respectively. The illustrated system 100 can also include a public network 118 (e.g., the Internet) that delivers data among the clients 114a and 114b (collectively referred to as “client 114”), the SNP 120, the financial platform 130, the financial institution 180, and an optional private network 150 that delivers data between the SNP 120 and the financial platform 130. The social network platform 120, as a third party, can be commercially partnered with the financial platform 130 and one or more financial institutions 180. For example, as described below with reference to FIG. 2, a single financial institution can be chosen as an exclusive regional partner of the social network platform.

In some instances, the social network platform 120 and the financial platform 130 can communicate solely over the public network 118, solely over the private network 150, or using both the public network 118 and the private network 150, or any other appropriate network or connection. The financial platform 130 can be communicatively coupled with the financial institution 180, for example, via the public network 118, a private network 150, a dedicated link, or any other appropriate network or connection. In some instances, the system 100 can include multiple financial institutions and the financial platform 130 can be communicably coupled to one or more of the multiple financial institutions.

The system 100 can include additional or different components, and the components of the system can be arranged as shown in FIG. 1 or in any other suitable configuration. For example, although the social network platform 120 and the financial platform 130 are shown as two separate and distinct entities in FIG. 1, in some implementations, the social network platform 120 and the financial platform 130 can be integrated into a single platform.

In some instances, a user interacting with user interfaces presented on the client 114, may interact with the SNP 120 to access and participate in a prestige program. The prestige program can link possessions of a user 112 associated with a financial institution (e.g., the financial institution 180) with a status of the user 112 in the SNP 120. The status of the user can be represented, for example, by a visualization on the SNP. The financial platform 130 may interact with the SNP 120, the financial institution 180 to define, create, edit, update, or delete user's status based on the possessions of the user 112 associated with the financial institution 180. As an example process, the financial platform 130 may define criteria of a status plan (e.g., prestige status plan 158) and send instructions on transactions that impact the user's status to the SNP 120 to present to the user 112. For example, computer instructions for subsequent display of the transaction instructions to the user 112 via the user interface can be communicated to the social network platform 120. The transaction instructions can specify how to make transactions with one or more financial institutions to qualify for the criteria of the prestige plan. The user 112 can select and perform a certain transaction according to the instructions for a desired status. The financial platform 130 may receive a transaction confirmation from the financial institution 180, check the user's possessions associated with the financial institution 180 (e.g., represented by possession information 182), and determine whether the criteria of the desired status are satisfied. If the criteria are met, the financial platform 130 can send a request to the SNP 120 to change the user's visualization so that it reflects the user's desired status. Additional and different processes and interactions can be performed in the example environment 100.

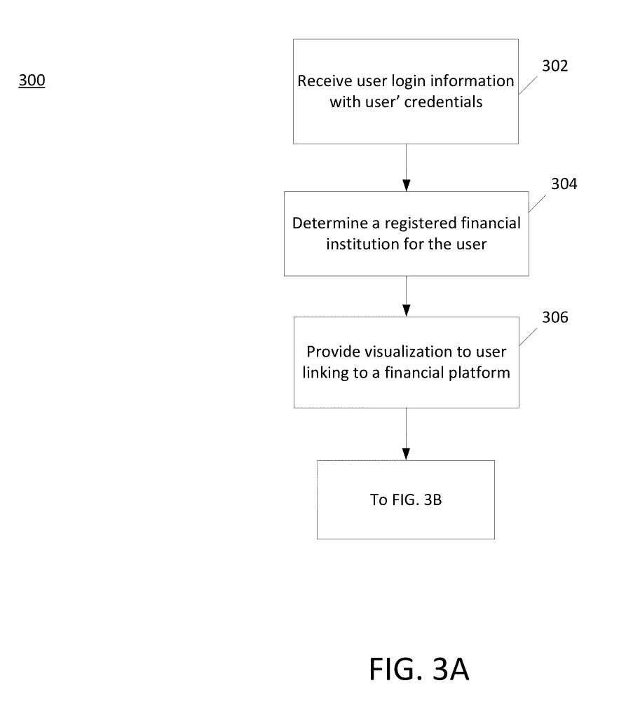

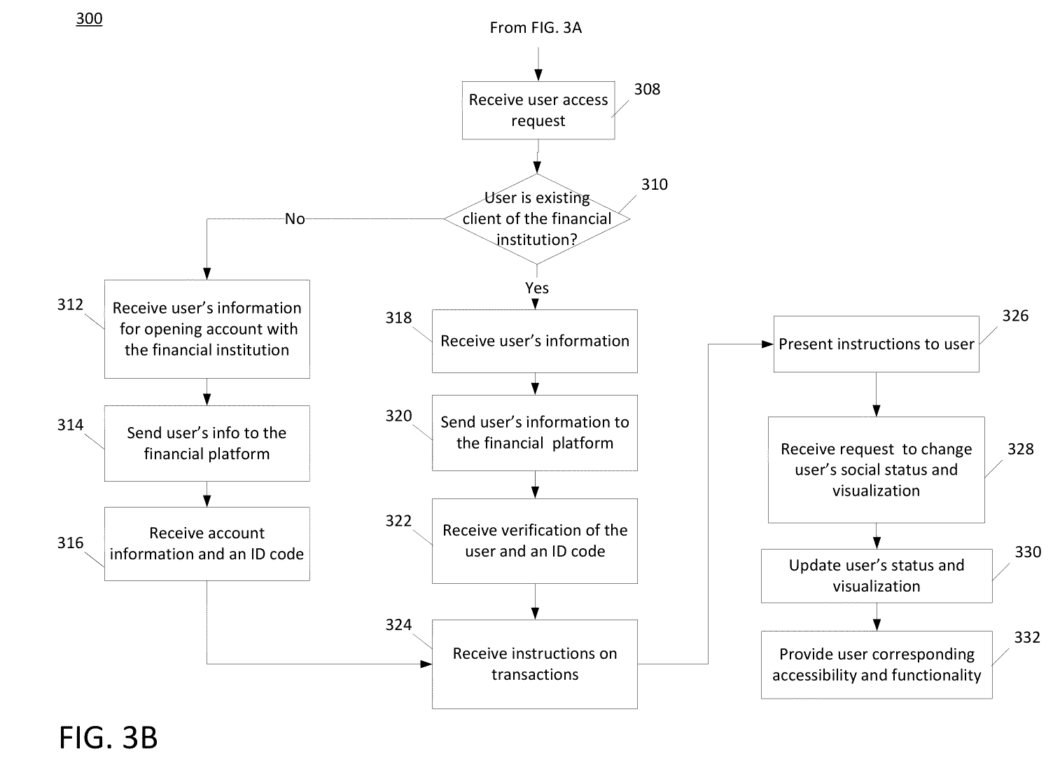

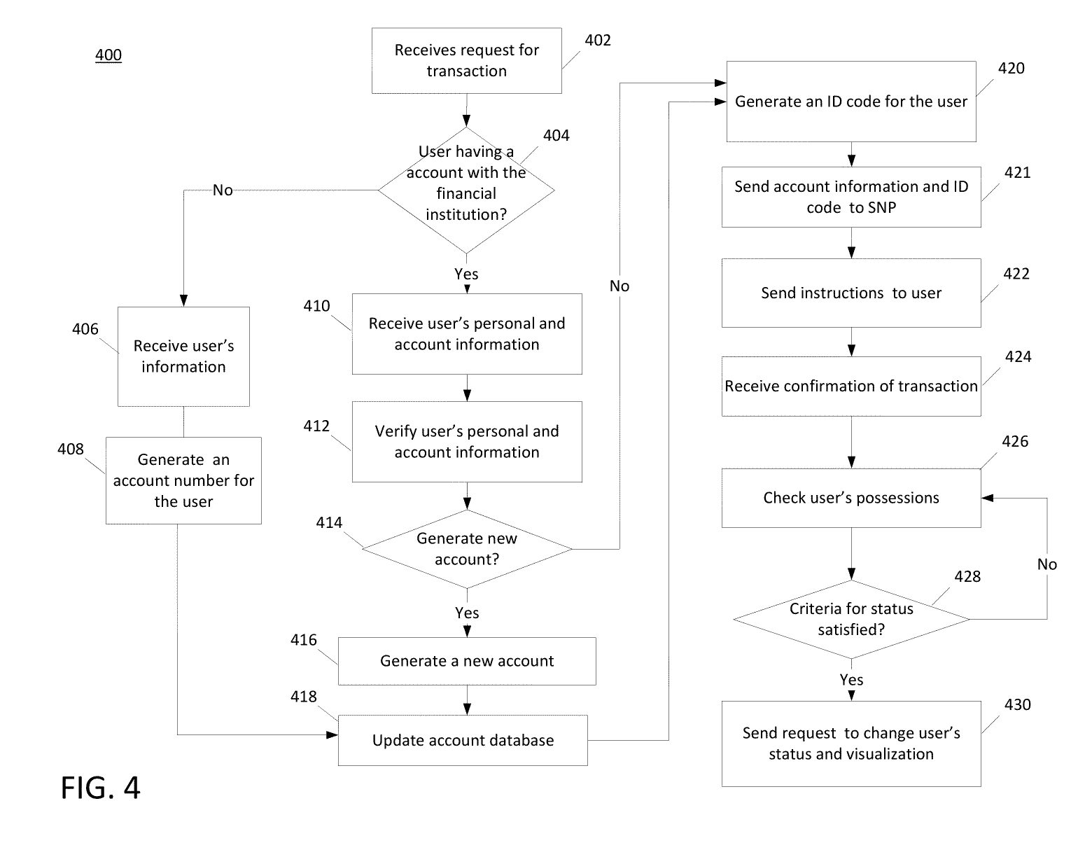

For example, determining possession information (e.g., possession information 182) of the user of the social network platform includes communicating a request to one of the financial institutions, and receiving possession information from the financial institution. In some instances, a transaction request of the user can be received; the transaction request can be communicated to one of the financial institutions; a confirmation of the transaction can be received from the financial institution; and the possession information of the user after the transaction can be determined. In some instances, if the user is not an existing client of one of the financial institutions, the user's information can be read from a database of the social network platform; and a new account can be opened for the user with one of the financial institutions using the user's information. Example techniques for these operations are previously described with respect to FIGS. 3 and 4.

The social network platform 120 can include a user profile database 122, one or more SNP application programming interfaces (APIs) 125, and any other appropriate module for providing social network service, integrating the financial platform 130, or any suitable other functionalities. The user profile database 122 can store user profiles that the users 112 of the social network platform 120 create for them. For example, users 112 can upload a picture of themselves and can establish relationships or links to other users, e.g., users can be “friends” with other users. The user profile database 122 can include user-specific information, for example, usernames, passwords, county/regional information, group information, status information, etc. Additional or different information can be included in the user profile database 122.

The SNP APIs 125 can include a financial platform manager API 124, a visualization manager API 126, a database (DB) manager API 128, or any other appropriate API. An API may include specifications for routines, data structures, and object classes. The API may be either computer-language independent or dependent and refer to a complete interface, a single function, or even a set of APIs. For example, the API may be software written in JAVA, C++, or other suitable language providing data in extensible markup language (XML) format or other suitable format. The API can provide functionalities and software services to the example system 100.

In some instances, the financial platform manager API 124 can provide functionalities of the prestige program related to the SNP 120. For example, the financial platform manager API 124 can provide and manage a user interface of the prestige program on the SNP 120. The user interface of the prestige program can be presented to the user, for example, when a request to access the prestige program is received. The user interface of the prestige program can include a visualization, a hyperlinked button, an information page, a pop-up window, or in any other appropriate form. In some implementations, the visualization can be used to indicate the user's status. The hyperlinked button can be a request to access button that can trigger an access request for the prestige program, or a button that can direct to an information page. The information page can contain information related to the user's status, for example, an introduction of the prestige program, a status plan with multiple status and their respective criteria, instructions on how to participate in the prestige program and how to make transactions to satisfy the criteria, FAQ, or any other appropriate information.

In some implementations, the financial platform manager API 124 can interact with the financial platform 130 that is communicably coupled to the SNP 120. For example, the financial platform manager API 124 may define and provide communication interfaces between the SNP 120 and the financial platform 130; send and receive data (e.g., user's information, transaction request, status update request, etc.) to and from the financial platform 130; monitor the activities of the financial platform 130, or any other appropriate operation. In some implementations, the financial platform manager API 124 can be operable to choose a financial institution (e.g., 180) to participate in the prestige program. In these cases, the financial platform manager API 124 can be further operable to register the selected financial institution in a database of the SNP 120, and determine regional variables for the registered financial institution. In some instances, the financial platform manager API 124 can provide additional or different features and functionalities.

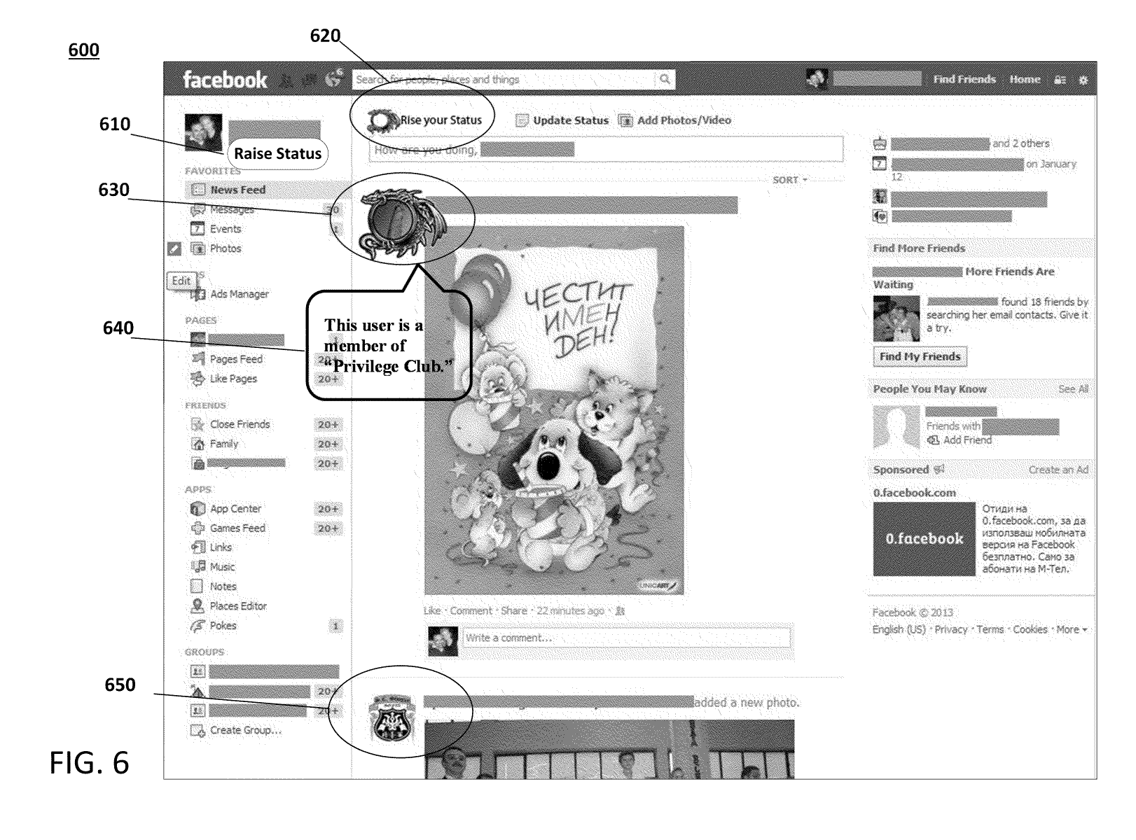

The visualization manager API 126 may create, access, modify, delete, or otherwise manage a visualization in the SNP 120. The visualization can indicate a status or prestige of the user. The visualization can be an icon, image, text, flash, animation, or any other type of representation. The visualization can be a part of the user interface of the prestige program. This visualization can be displayed in user interface of the SNP and can be visible to the user himself as well as to other users of the SNP (such as users who are browsing the user's status, homepage, profile or any other appropriate place that the user's name may appear). Some example visualizations are shown in FIG. 6. As an example, the visualization can contain a hyperlink directing to the user interface of the prestige program. In some instances, the visualization manager API 126 may receive a request from the financial platform 130, or an instruction from the financial platform manager API 124 to update the visualization of a user to reflect a current status of the user.

The database manager API 128 may access, modify, delete, or otherwise manage a database of the SNP 120, for example, the user profile database 122. In some implementations, the database manager API 128 can also control information related to, for example, user's account and status, registered financial institution of the prestige program, or any other appropriate information.

The financial platform 130 of the example system 100 can include an interface 132, a processor 134, one or more financial platform APIs 135, an authentication module 144, a memory 150, or any other appropriate module for providing the prestige program service. Additional or different features and functionalities can also be defined with the financial platform 130.

The interface 132 is used by the financial platform 130 for communicating with other systems in a distributed environment—including within the environment 100—connected to the public network 118 and the private network 150, for example, the financial institution 180, the client(s) 114, and the SNP 120, as well as other systems communicably coupled to the public network 118 or the private network 150 (not illustrated). Generally, the interface 132 comprises logic encoded in software and/or hardware in a suitable combination and operable to communicate with the public network 118 or the private network 150. More specifically, the interface 132 may comprise software supporting one or more communication protocols associated with communications such that interface's hardware is operable to communicate physical signals within and outside of the illustrated environment 100.

As also illustrated in FIG. 1, the financial platform 130 includes a processor 134. Although illustrated as a single processor 134 in FIG. 1, two or more processors may be used according to particular needs, desires, or particular implementations of the environment 100. Each processor 134 may be a central processing unit (CPU), a blade, an application specific integrated circuit (ASIC), a field-programmable gate array (FPGA), or another suitable component. Generally, the processor 134 executes instructions and manipulates data to perform the operations of the financial platform 130. Specifically, the processor 134 executes the functionality required to interact with the financial institution 180 and the SNP 120, as well as to perform the operations associated with the SNP 120 and the financial platform 130 as a whole, and those components' related modules and functionality, including linking possessions of a user 112 of the SNP 120 with a status of the user 112 in the SNP 120.

The financial platform 130 is illustrated as including multiple financial platform APIs 135. In some implementations, the financial platform APIs 135, as well as its components, can be any application, program, or other software for managing and performing operations associated with, for example, user's possessions and user's status. To perform these operations, the financial platform APIs are illustrated as including several components, including: a status manager API 136, a database (DB) manager API 138, and a transaction manager API 140. These components, as well as any other or alternative components, assist the financial platform 130 in defining, creating, modifying, and deleting the user's status, for example, based on the user's possessions.

The status manager API 136 may define, create, modify, delete, or otherwise manage a status of a user of the SNP 120, for example, based on a user's possessions associated with a financial institution. In some implementations, the status manager API 136 can define criteria of a status plan linking possessions of a user of the SNP 120 with a status of the user. In some instances, the status manager 136 can generate instructions on transactions that impact the user's status, and send the instructions to the SNP 120. In some implementations, the status manager API 136 can read possessions of the user in his account and determine whether the possessions of the user satisfy certain criteria of the status plan. Based on the determination, the status manger API 136 may send a request, for example, to the SNP APIs 125, to change the user's status so that the visualization of the user can reflect the user's current status. In some instances, the status manager API 136 may send a notification to the database manager API 138 to update the user's status information 154 in the database. For example, the qualified prestige status may be a new prestige status for the user. In this case, storing, in the database, the prestige status of the user includes updating, in the database, the prestige status of the user to the new prestige status; and communicating the prestige status to the social network platform for subsequent display of the prestige status includes communicating the new prestige status to the social network platform for subsequent display of the new prestige status. The new prestige status can be represented by an updated visualization reflecting the new prestige status.

The database manager API 138 can access, modify, delete, or otherwise manage, a database associated with the financial platform 130. The database can include information related to user's account, user's status, the financial institution registered in the prestige program, or any other appropriate information. In some implementations, the database manager API 138 can manage the account database 152. For instance, the database manager API 138 can open a new account with a financial institution and generate an ID code for a user who participates in the prestige program. The database manage API 138 can send the account information and the ID code to the SNP 120. The database manager API 138 can also monitor account activities, modify account information, update user's status, or execute any other appropriate functionality.

The transaction manager API 140 can perform operations related to transactions associated with financial platform 130. In some instances, the transaction manager API 140 can receive the user's selected transaction request and receive transaction confirmation from the relevant financial institution (e.g., the financial institution 180). In some implementations, the transaction manager API 140 can manage transactions of the user's possessions and notify the database manager API 138, or the status manager API 136 about the transactions.

The authentication module 144 can perform authentication of the operations related to the financial platform 130. The authentication module 144 may authenticate, for example, the user's login information when the user tries to access the account, the transactions associated with financial platform 130, or any other appropriate interaction among the user 112, the SNP 120, the financial platform 130, and the financial institution 180. For example, authentication of the user can be performed. In this example, the authentication module 114 can perform authentication of the user to verify the identity of the user, and determine whether to grant access to the user based on the authentication. In some implementations, the authentication module 144 can manage the authentication information 156 in the memory 150.

Memory 150 of the financial platform 130 may be a single or multiple memories. The memory 150 may include any type of memory or database module and may take the form of volatile and/or non-volatile memory including, without limitation, magnetic media, optical media, random access memory (RAM), read-only memory (ROM), removable media, or any other suitable local or remote memory component. The memory 150 may store various objects or data, including caches, classes, frameworks, applications, backup data, business objects, jobs, web pages, web page templates, database tables, repositories storing business and/or dynamic information, business object universes, database and data source connection-related information, product information, customer information, and any other appropriate information including any parameters, variables, algorithms, instructions, rules, constraints, or references thereto associated with the purposes of the financial platform 130. Additionally, the memory 150 may include any other appropriate data, such as VPN applications, firmware logs and policies, firewall policies, a security or access log, print or other reporting files, as well as others.

As illustrated in FIG. 1, memory 150 includes an account database 152, status information 154, authentication information 156. The account database 152 can include user's account information (e.g., user's name, account number, account type, etc.) associated with the financial platform 130. In some implementations, the account database 152 can include the ID code generated for the user who participates in the prestige program. The status information 154 can include user's status, the criteria defined for the status plan, or any other appropriate information related to the prestige program. The authentication information 156 can include authentication code, authentication key, or any appropriate information for verifying the identity of the user and the legitimacy of the transactions.

The financial institution 180 is communicably coupled to the financial platform 130. In some implementations, the financial institution 180 can control and manage the financial platform 130. Although illustrated as a single financial institution 180 in FIG. 1, two or more financial institutions may be included according to particular needs, desires, or particular implementations of the environment 100. Each financial institution 180 can be a bank, a charity organization, a manufacturer, a merchant, a service provider, or any other appropriate corporation, organization, or a third party related to the user's possession information. To the point, the financial institution 180 can encompass financial institutions and other entities that can perform a type of financial activity that can be electronically measured, recorded, or otherwise enable some “social stratification.” For example, the financial activity can include banking, merchandising, donating, fundraising, or any other appropriate activity that can reflect or affect possessions of a user. As another example, the financial activity can include time donated by the user to a particular cause or charity. These, and other, financial activities are stored as possession information (e.g., possession information 182) related to the user.

Generally, the client 114, the SNP 120, the financial platform 130, the financial institution 180 (and other components within environment 100) may be communicably coupled with a public network 118 or a private network 150 that facilitates wireless or wireline communications between the components of the environment 100, as well as with any other local or remote computer, such as additional clients, servers, or other devices communicably coupled to the public network 118 or the private network 150, including those not illustrated in FIG. 1. In the illustrated environment, the public network 118 and the private network 150 are depicted as a single network, respectively, but may be comprised of more than one network without departing from the scope of this disclosure, so long as at least a portion of the public network 118 or the private network 150 may facilitate communications between senders and recipients. In some instances, one or more of the components associated with the system may be included within the public network 118 or the private network 150 as one or more cloud-based services or operations.

The public network 118 (or at least a portion of the public network 118) may represent a connection to the Internet. The private network 150 may be all or a portion of an enterprise or secured network, while in another instance, at least a portion of the private network 150 may represent a connection to the Internet. In some instances, a portion of the public network 118 or the private network 150 may include a portion of a cellular or mobile data network or other network capable of relaying short message service (SMS) or multimedia messaging service (MMS) messages, as well as other suitable mobile data messaging. In some instances, a portion of the public network 118 or the private network 150 may be a virtual private network (VPN). Further, all or a portion of the public network 118 or the private network 150 can comprise either a wireline or wireless link. Example wireless links may include 802.11 a/b/g/n, 802.20, WiMax, LTE/LTE-Advanced, 3G, 4G, and/or any other appropriate wireless link. In other words, the public network 118 or the private network 150 encompasses any internal or external network, networks, sub-network, or combination thereof operable to facilitate communications between various computing components inside and outside the illustrated environment 100. The public network 118 or the private network 150 may communicate, for example, Internet Protocol (IP) packets, Frame Relay frames, Asynchronous Transfer Mode (ATM) cells, voice, video, data, and other suitable information between network addresses. The public network 118 or the private network 150 may also include one or more local area networks (LANs), radio access networks (RANs), metropolitan area networks (MANs), wide area networks (WANs), all or a portion of the Internet, and/or any other communication system or systems at one or more locations.

Regardless of the particular implementation, “software” may include computer-readable instructions, firmware, wired and/or programmed hardware, or any combination thereof on a tangible medium (transitory or non-transitory, as appropriate) operable, when executed, to perform at least the processes and operations described herein. Indeed, each software component may be fully or partially written or described in any appropriate computer language including C, C++, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

While FIG. 1 is described as containing or being associated with a plurality of elements, not all elements illustrated within environment 100 of FIG. 1 may be utilized in each alternative implementation of the present disclosure. For example, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes, in addition to those purposes described herein.

FIG. 2 is a flow chart illustrating an example process 200 for integrating a social network platform (SNP) with a financial institution. For clarity of presentation, the description that follows generally describes method 200 in the context of FIG. 1. However, it will be understood that method 200 may be performed, for example, by any other suitable system, environment, software, and hardware, or a combination of systems, environments, software, and hardware as appropriate.

At 202, a financial institution can be chosen as a regional partner of the SNP for a certain type of financial activity. The financial activity can include banking, merchandising, donation, or any other appropriate activity that can reflect or affect possessions of a user. As a specific example, the SNP may select Bank A, Bank B, and Bank C as the exclusive partner for the city A, state B, and country C, respectively, for banking-related financial activities and link possessions of a user in the respective bank with a status of the user in the SNP. In some aspects of implementations, more than one financial institution can be chosen as the SNP's partners for a certain region and/or a certain type of financial activity.

At 204, the financial institution is registered with the SNP. Information about the financial institution, e.g., name, locations, size, services, etc., can be registered and stored in a database of the SNP or the financial platform. As an example, the information of the financial institution may be stored and managed by the database manager API 128 of the SNP 120 in the example system 100.

At 206, regional variables can be determined for the registered financial institution. For example, the regional variables may represent the dependence between an identifier of a user and a regional partner of the SNP. The identifier can include the user's login information (e.g., an IP address, a domain name of the login site, etc.), user's profile information (e.g., a residence address, area or country code of a telephone number, etc.), or any other appropriate information. Based on the regional variables, a regional partner of the SNP can be identified for the user. For instance, different IP addresses, domain names, or any other appropriate identifier can be allocated and distributed amongst organizations in their respective location regions. As an example, the SNP may define IP address ranges for Bank D, Bank E, and Bank F that are regional partners of country G, country H, and country I, respectively. By checking which IP address ranges the user's IP address falls in, a corresponding bank for the user can be identified. In some implementations, the regional variables can be determined by the financial platform manager API 124, stored in the SNP database, and managed by the database manager API 128 of the SNP 120.

FIG. 3A-B is a flow chart illustrating an example process 300 for providing a prestige program on an SNP to a user. For clarity of presentation, the description that follows generally describes method 300 in the context of FIG. 1. However, it will be understood that method 300 may be performed, for example, by any other suitable system, environment, software, and hardware, or a combination of systems, environments, software, and hardware as appropriate.

At 302, user login information is received. For example, an SNP may receive user login information with his credentials, for example, username, password, safety questions, etc. In some implementations, authentication can be performed to verify the identity of the user. For example, the SNP may check whether the login information matches the user's information stored in the SNP database, and decide whether to grant access to the user accordingly.

At 304, a registered financial institution is determined for the user for the prestige program. In some instances, the registered financial institution can be determined based on certain attributes (e.g., location) of the user. In some implementations, the SNP may determine a registered financial institution for the user according to certain predefined rules, such as the regional variables defined at 204 in FIG. 2. As a specific example, the SNP may scan the IP address of the user, identify his geographic location (e.g., with some geolocation tools/software), and determine a registered financial institution for the user based on the defined regional variables that define the relationship between the user's geographic location and a corresponding regional partner. In some implementations, the user's preferences may be considered in determining a registered financial institution for him. For example, the user may select or input a registered financial institution as his financial institution for the prestige program. In some instances, the determined registered financial institution can be, for example, represented by an indicator, stored in the SNP database. The indicator can be used for all future processing of the user related to the prestige program for linking possessions of the user with his status in the SNP.

At 306, visualization is provided to the SNP for rendering. The visualization can be a visualization of the prestige program, for example, as shown and described below with respect to FIG. 6. The visualization can be rendered or otherwise presented via a user interface to visually indicate a user's prestige status. In some implementations, the visualization can be managed, for example, by the visualization manager API 126 in FIG. 1, or by any other appropriate module.

Referring to FIG. 3B, at 308, a user access request can be received. The access request can include a request to access the prestige program that links the user's possessions with the status in the SNP. In some instances, the access request can be received and processed by, for example, the financial platform manager API 124, or any other appropriate implementation module. In some implementations, the access request may be triggered by the user accessing the user interface of the prestige program, by clicking a hyperlinked visualization, by the user hitting, for example, a “raise your status” button displayed on the user interface of the SNP, or by any other action predefined for the prestige program, for example, by the SNP APIs 125, the financial platform 130, etc.

At 310, a determination is made whether the user is an existing client of the determined financial institution associated with the financial platform. The determination may be performed, for instance, by the financial platform manager API 124, the financial platform 130, or any other appropriate implementation module. In some implementations, the determination can be made based on certain user-specific information (e.g., user's name, address, telephone number, identifier, etc.) stored in the SNP database. For example, the user may have an identifier indicating whether the user is an existing client of the financial institution or not. In some implementations, the determination can be made based on the user's input. For example, the implementing system may send an inquiry (e.g., in a pop-up window) to the user. The user may then select or input whether he is an existing client of the determined financial institution. In some implementations, the SNP is aware of whether he is an existing client based on an indication from the financial platform (e.g., 130), or the financial institution (e.g., 180).

At 312, if the user is not an existing client of the financial institution, user's information can be received for opening a new account with the financial institution. The user's information can include one or more of, for example, the user's name, email address, home/business address, telephone number, identification number (e.g., social security number, driver's license number, etc.), occupation, or any other appropriate personal information. In some implementations, some or all of the user's information can be received by the user's input, or from the user's profile stored in the database (e.g., user profile database 122) of the SNP.

At 314, the user's information is sent to the financial platform. For example, the user's information can be sent by the financial platform manager API 124 to the financial platform 130. Such information can be used to register the user as a new client and open a new account at the financial institution associated with the financial platform.

At 316, account information and an identification (ID) code for the user can be received. In some implementations, the financial platform can create a new account, generate a unique ID code for the user, and send the account information, the ID code, or any other appropriate information back to the SNP. The account information can include account number, account type, or any other appropriate information of the created account. The ID code can indicate, for example, the user is a participator of the prestige program of the financial institution; the user is a client of the financial institution; or any other appropriate indication. The social network platform can change the user's status stored in the database of the social network platform and update the user's visualization to reflect the current status using the unique ID code. The ID code can be used for later processing and interactions associated with the user and the prestige program among the SNP, the financial platform, and the financial institution. For example, operations using the unique ID code are subsequently described with respect to 322 and 328 of FIGS. 3 and 420, 421, 424 and 430 of FIG. 4. In some implementations, the SNP can read or update the user's information upon the receipt of the account information and the ID code for the user, for example, by the database manager API 128.

At 318, if the user is an existing client of the financial institution, the user's information can be received for verifying the user's account with the financial institution. The user's information can include one or more of, for example, name, email address, account number, authentication information (e.g., login username and password), identification number (e.g., social security number, driver license number, etc.), or any other appropriate personal information. In some implementations, some or all of the user's information can be received by the user's input, or from the user's profile stored in the database of the SNP.

At 320, the user's information is sent to the financial platform. For example, the user's information can be sent by the financial platform manager API 124 to the financial platform 130. Such information can be used to verify the user's identity and identify the user's account information at the financial institution.

At 322, verification of the user and an ID code for the user can be received, for example, from the financial platform. In some implementations, the financial platform may verify the user as an existing client, identify the user's account, generate a unique ID code for the user, and send the verification and the ID code back to the SNP. The verification may include account number, account type, or any other appropriate information of the verified account of the user. The ID code can indicate, for example, the user is a participant in the prestige program of the financial institution; the user is a client of the financial institution; or any other appropriate indication. The ID code can be used for later processing and interactions associated with the user and the prestige program among the SNP, the financial platform, and the financial institution. In some implementations, the SNP can update the user's information upon the receipt of the account information and the ID code for the user, for example, by the database manager API 128.

At 324, instructions on transactions that impact the user's status from the financial platform can be received, for example, from the financial platform. In some instances, the instructions can include, for example, an introduction of the prestige program that can link possessions of the user associated with the financial platform with a status of the user in the SNP. A status plan, criteria of the status plan, how to make transactions to satisfy the criteria, or any other appropriate information can be included in the instructions. In some implementations, the status plan can include multiple statuses with respective criteria. For example, the prestige status plan of the prestige program includes multiple tiered statuses (e.g., “Rich,” “Ultra-Rich,” etc.). The status can be reflected, for example, by the visualization in the SNP. Various criteria for the statuses can be defined. For example, the criteria for the statuses can be defined based on an amount of user's possessions associated with the financial institution for an amount of time. In another example, a single financial institution can be an exclusive regional partner of the social network platform; and then at least one of the criteria indicates required possessions at the single financial institution to qualify for the respective prestige status. In this case, determining possession information of the user includes determining possession information of the user at the single financial institution. A user's status can be raised and lowered depending on whether the user's possession information qualify for the respective criteria of the raised or lower status, for example, as described with respect to 324.

As one example, a “Trial Higher Rank” status can be an initial status of a user who participates in the prestige program. If the user deposits x₁ amount of funds in his account at the financial institution for y₁ duration (e.g., a fixed term of 3, 6, 9, etc., months), the user can be entitled with a “Rich” status. If the user has x₂ amount of funds in in his account at the financial institution for y₂ duration, the status of the user may rise to “Ultra-Rich.” In some implementations, users with “Ultra-Rich” status can have more privileges than users with “Rich” status, and further more privileges than users with “Trial Higher Rank” status. On the other hand, if a user fails to maintain, for example, x₁ amount of funds in his account at the financial institution for y₁ duration, the status of the user may drop to “Trial Higher Rank.” If a user does not deposit or refund x₀ amount of funds to his account in a certain period of time y₀, the user's status “Trial Higher Rank” may disappear. The user may lose corresponding privileges associated with the status when the status drops or disappears. In this example, the parameters such as x₀, y₀, x₁, y₁, x₂, y₂ can be configured, for example, by the financial institution, the SNP, or any other appropriate party. The financial institution can include a bank, for instance.

As another example, the financial institution can include a charity organization, or a charity account. In some instances, if the user transfers or deposits a certain amount of funds in a charity account associated with the financial institution, the user can be entitled a status as “Angel.”

As another example, the financial institution can be a merchant, a manufacturer, a service provider, or any other appropriate organization. For example, the financial institution can be a luxury car XYZ producer. If a user of the SNP is a client of the luxury car XYZ producer, the user may be able to input personal information in the SNP about the car that he bought from the producer. The user can then have a status, such as, “I officially own luxury car XYZ” in his SNP profile after verification of the information of him and his car.

As another example, the financial institution can be an airline company or a travel agency. The user may have a “world explorer” status if, for example, the user's purchase or travel history indicates that he have been to a certain number of places during a certain period of time.

Additional and different statuses and criteria can be defined.

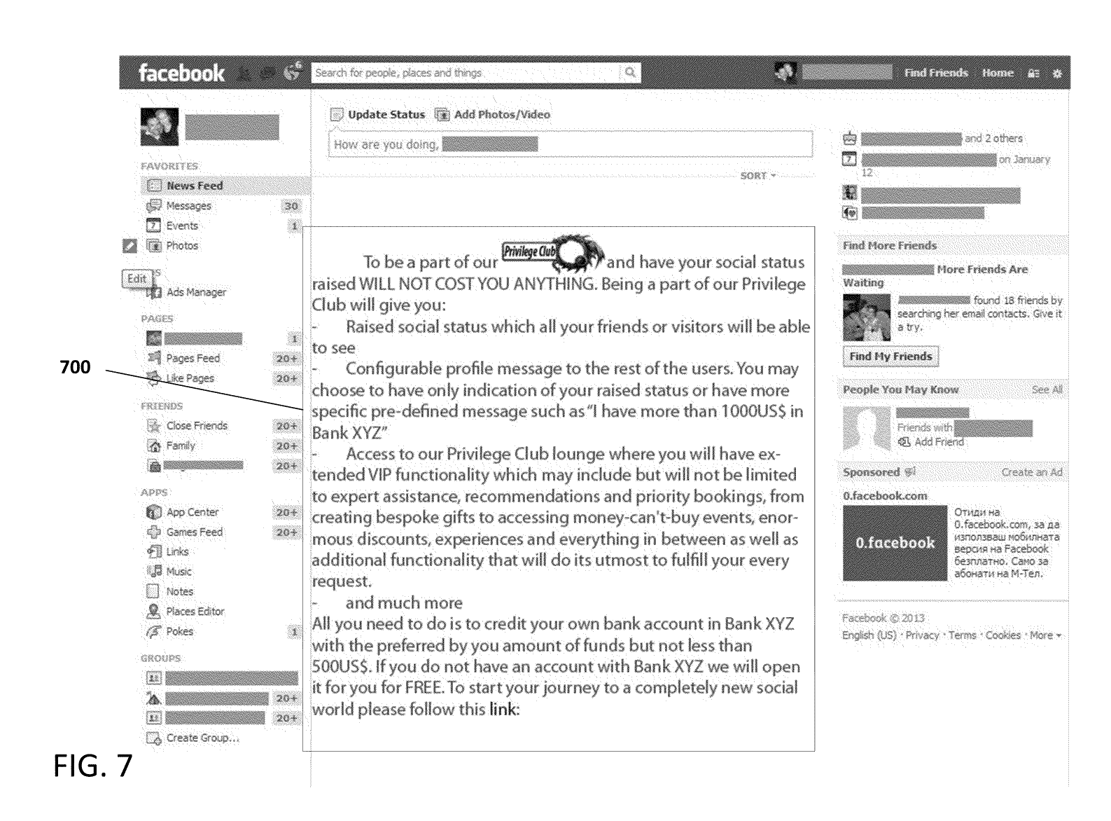

At 326, the instructions are presented to the user. For example, the instructions can be displayed on the user interface of the SNP. As an example of implementations, the instructions can be shown in a separate information page informing the user about the criteria he needs to fulfill in order to get his status raised. An example information page with instructions is illustrated in FIG. 7.

At 328, a request to change the user's social status and visualization can be received. For example, the request can be received by the financial platform manager API 124 from the financial platform 130. The request can be received with the unique ID code of the user, for example, for identifying the user's information associated with the prestige program. The request can be, for example, to raise the user's status if the possessions of the user associated with the financial institution satisfy criteria of a raise of the user's status, to lower the user's status if the possessions of the user associated with the financial institution satisfy criteria of a drop of the user's status, or any other appropriate indication.

At 330, the user's prestige status and visualization can be updated. For example, the SNP may update the user's status according to the request (e.g., a raise, a drop, or any other appropriate modification of the user's status) from the financial platform. In some implementations, the user's status or visualization can be updated based at least in part on the user's preferences. For example, the user may design, modify, delete, or otherwise manage his status or visualization if the status or visualization is verified or approved, for example, by the financial platform, or the financial institution. In some implementations, multiple statuses can be displayed at the same time. Specifically, the prestige status is a first prestige status and the visualization is a first visualization. If the comparison shows that the determined possession information qualifies for a second prestige status of the prestige status plan, the second prestige status of the user can be stored, by the one or more processors of the financial platform, in the database. The second prestige status can be communicated, by the one or more processors of the financial platform, to the social network platform for subsequent display of the first prestige status and the second prestige status at the same time. The second prestige status can be represented by a second visualization that is displayed via the user interface and is visible to other users of the social network platform.

In some cases, the user may be able to configure whether to show a status to another user or not. For instance, communicating the prestige status to the social network platform enables the user to design, modify, or delete the visualization of the prestige status. Upon receipt of the prestige status of the user, the social network platform can prepare and display a visualization of the prestige status so that it is visible to other users of the social network platform. In some instances, if the user chooses to design, modify, delete, or otherwise manage the visualization of his prestige status, the user's operations on visualization can be communicated back to the financial platform for approval. The financial platform can determine, for example, whether the requested visualization faithfully reflects the possessions of the user at the financial institution. If so, the financial platform can approve the visualization and communicate the approved visualization together with the prestige status of the user to the social network platform. The social network platform can then update the visualization to show the approved visualization of the user. As an example, a user deposited US $100000 in the bank account can satisfy, for example, an “Ultra-Rich” status. The user's prestige status and visualization can be updated to “Ultra-Rich.” Or the user can change his visualization to “Raised Social Status,” “Rich,” “The user is having more than US $100000 in a bank,” or any other appropriate visualization.

At 332, corresponding accessibility and functionality can be provided based on the status of the user. In some implementations, different statuses may enable the user with different accessibilities or functionalities. In some implementations, a higher status can qualify the user for better accessibilities or functionalities and provide the user more benefits. In some implementations, users joined in the prestige program can have better accessibilities or functionalities than users of the SNP who are not enrolled in the prestige program. In some implementations, the accessibilities or functionalities can include, but are not limited to, priority access to products or services (e.g., limited-edition merchandise, bespoke gifts, reservations, booking, money-can't-buy events, etc.), expert assistance and recommendations, exclusive offers and discounts, enhanced customer services or user experience, etc. For example, in response to determining the qualified prestige status of the user, the user can be provided access to money-can't-buy events, such as events that are exclusive to the group of users that have a certain level of prestige status. In some other instances, the user's status in the SNP can be evaluated by the financial institution (e.g., a bank) for example, providing loans. Users participating in the prestige program can be eligible and have privileges for direct loans from the financial institution compared with other users who do not participate in the prestige program.

In some instances, users with a trial status (e.g., “Trial Higher Rank”) may have a chance for a limited period of time to experience extended functionalities provided to a user with an official status (e.g., “Rich”). By fulfilling the criteria of an official status, for example, by depositing a certain amount of funds in the account of the financial institution, the user can keep the extended functionalities. In some aspects of implementations, the user with certain statuses can request or customize his own accessibilities or functionalities. In the above example where the user deposited US $100000 in the bank account and qualified for an “Ultra-Rich” status, the user can have extended accessibilities and functionalities corresponding to the “Ultra-Rich” status. If the user chooses to change his status or visualization to “Rich,” he can be given accessibilities and functionalities corresponding to the “Rich” status, or he can choose not to have the “Ultra-Rich” indication but to take full advantage of the extended accessibilities and functionalities of the “Ultra-Rich” status.

In some instances, users with the same status can be considered as members of a group. Multiple groups can be defined within the SNP. Intra-group functionalities and inter-group functionalities can be provided to the group members. For instance, the functionalities can include methods for connecting the members within the group (e.g., providing networking opportunities for group members, matching people for romantic or dating purposes). In some other instances, the groups can be used by merchants and service providers to target consumer groups, for example, based on the proven financial potential, or any other appropriate attributes derived from the statuses or vitalizations of the users.

In some other instances, the prestige program can help the financial institution (e.g., merchant or service provider) to link their sales with the social status of an SNP user and attach their product or service to the user's visualization that is visible to other users. The status and visualization can serve as an advertisement and help the merchant or service provider to generate more sales and popularity.

In some other instances, the prestige program can provide a user that is seeking a business or life partner an indication of the other user's, for example, financial stability, in real life.

FIG. 4 is a flow chart illustrating an example process 400 for linking a user's possessions with the user's status in an SNP. For clarity of presentation, the description that follows generally describes method 400 in the context of FIG. 1. However, it will be understood that method 400 may be performed, for example, by any other suitable system, environment, software, and hardware, or a combination of systems, environments, software, and hardware, as appropriate.

At 402, a request for transaction is received. For example, the request (e.g., an http request) can be received by the financial platform (e.g., 130) from the SNP APIs (e.g., 125). In some instances, the request can indicate the user's selected transaction associated with the financial institution. The transaction can be selected, for instance, according to the status plan to satisfy a criterion of a desired status. In some implementations, the request can include the user' name, transaction type, or any other appropriate information for performing the transaction.

At 404, a determination whether can be made whether the user is an existing client of the financial institution associated with the financial platform. In some implementations, the determination can be performed by the financial platform 130 (e.g., the database manager API 138). For instance, the financial platform can search, for example, in the client database to see whether the user has an account with the financial institution.

At 406, if the user is not an existing client of the financial institution, the user's information can be received for opening a new account with the financial institution. For example, the user's information can be received by the financial platform 130 from the financial platform manager API 124. The user's information can include one or more of, for example, the user's name, email address, home/business address, telephone number, identification number (e.g., social security number, driver's license number, etc.), occupation, or any other appropriate personal information. In some implementations, some or all of the user's information can be received by the user's input, or from the user's profile stored in the database of the SNP.

At 408, a new account is generated for the user, for example, based on the user's information received from the SNP (e.g., the financial platform manager API 124). The user can be registered as a new client of the financial institution and an account number can be generated for the user for the prestige program.

At 410, if the user is an existing client of the financial institution, the user's personal information and account information can be received, for example, by the financial platform 130 from the financial platform manager API 124. The user's personal information and account information can include one or more of, for example, name, email address, account number, authentication information (e.g., a login username and password), identification number (e.g., social security number, driver's license number, etc.), or any other appropriate information.

At 412, the user's personal and account information can be verified. For example, the financial platform may search for a match in the account/client database of the financial institution. In some implementations, authentication can be performed to verify the identity of the user, for example, based on the authentication information, the identification number, or any other appropriate information.

At 414, whether to generate a new account for the user is determined. In some instances, the determination can be based on whether the user is a participant in the prestige program (although the user is an existing client of the financial institution). If the user is not a participant in the prestige program, a new account dedicated to the prestige program may be desirable because, for example, the new account can help avoid complication or interference with the rest of the financial activities of the user associated with the financial institution. In some other implementations, an existing account of the user can be used. In this case, the example process may proceed to 420.

At 416, if a new account is determined to be necessary, the new account is generated for the user. In some implementations, the SNP and the financial institution may collaborate in determining properties (e.g., type, functionality, operation procedure, etc.) of the new account. For example, the financial institution can form a so-called pool account deposit for the SNP where all the new deposits can flow into. The SNP may benefit from this pool account deposit based on a percentage over the total amount of funds attracted in deposits, similar to what Pension Funds are earning for keeping big amounts of funds in the banks In some other instances, the SNP may charge a flat fee for each account associated with the status platform.

At 418, the account database is updated, for example, to include the new account generated at 408 for the new client of the financial institution, or the new account generated at 416 for the existing client dedicated to the prestige program. In some instances, the account database is updated, for example, by the database manager API 138 to include the new account information.

At 420, an ID code for the user is generated, for example, by the financial platform. The ID code can be a unique identifier for the user. The ID code can indicate, for example, the user is a participant in the prestige program of the financial institution; the user is a client of the financial institution; or any other appropriate indication. The ID code can be used for later processing and interactions associated with the user and the prestige program among the SNP, the financial platform, and the financial institution. In some implementations, the financial platform can update the user's information, for example, by the database manager API 138, to include the ID code in the account/client database.

At 421, the account information and the ID code are sent to the SNP. For example, the account information and the ID code can be sent to the SNP 120 by the financial platform 130 (e.g., the database manager API 138). The account information can include account number, account type, or any other appropriate information of the created account.

At 422, instructions on transactions that impact the user's status are provided to the user. In some implementations, the instructions are sent to, for example, the financial platform manager API 124 from the status manager API 136. The instructions can include a status plan with multiple statuses and their respective criteria, how to make transactions to satisfy the criteria, or any other appropriate information. The criteria of the statuses can be defined, for example, by the financial institution, the SNP, or any combination of these or other appropriate parties.

At 424, confirmation of transaction can be received. In some implementations, the confirmation is received by the transaction manager API 140 from the financial institution 180. In some instances, the user can execute the transaction by, for example, going to an automatic teller machine (ATM) or a bank; using an online banking platform, or via any other appropriate payment service platform (e.g., PayPal™) to deposit or transfer a certain amount of funds into his newly-opened account with his ID code. Upon success of the transaction, the financial institution can send the confirmation of the transaction to the financial platform.

At 426, possessions of the user associated with the financial institution are checked. The possessions can include the user's funds deposited in a bank account, a property or merchandise (e.g., luxury car, house) that the user owns or purchased from a manufacturer or a merchant, a donation provided to a charity organization or deposited in a charity account, a purchase or service history recorded in a service provider, or any additional or different belongings of the user associated with a registered financial institution of the prestige program.

At 428, whether the possessions of the user satisfy the criteria of a status is determined. For example, the determination can be based on the criteria set up in the status plan as illustrated in the instructions. In some implementations, the determination can be performed at some predefined time, or on a regular basis. As an example, if the possessions of the user do not satisfy the criteria of a status at a first check, another check may be conducted later at a predefined time, or in a periodic manner.

At 430, a request to change user's status and visualization is sent. For example, the request can be sent from the status manager API 136 with the unique ID code of the user to the financial platform manager API 124 to change the user's status in the SNP, and to the visualization manager API 124 to update the user's visualization to reflect the current status of the user. The request can be, for example, to raise the user's status if the possessions of the user associated with the financial satisfy criteria of a raise of the user's status, to lower the user's status if the possessions of the user associated with the financial satisfy criteria of a drop of the user's status, or any other appropriate indication.

The example processes 200, 300, and 400 shown in FIGS. 2-4 can be modified or reconfigured to include additional, fewer, or different operations, which can be performed in the order shown or in a different order. In some instances, one or more of the operations can be repeated or iterated, for example, until a terminating condition is reached. In some implementations, one or more of the individual operations shown in FIGS. 2-4 can be executed as multiple separate operations, or one or more subsets of the operations shown in FIGS. 2-4 can be combined and executed as a single operation.

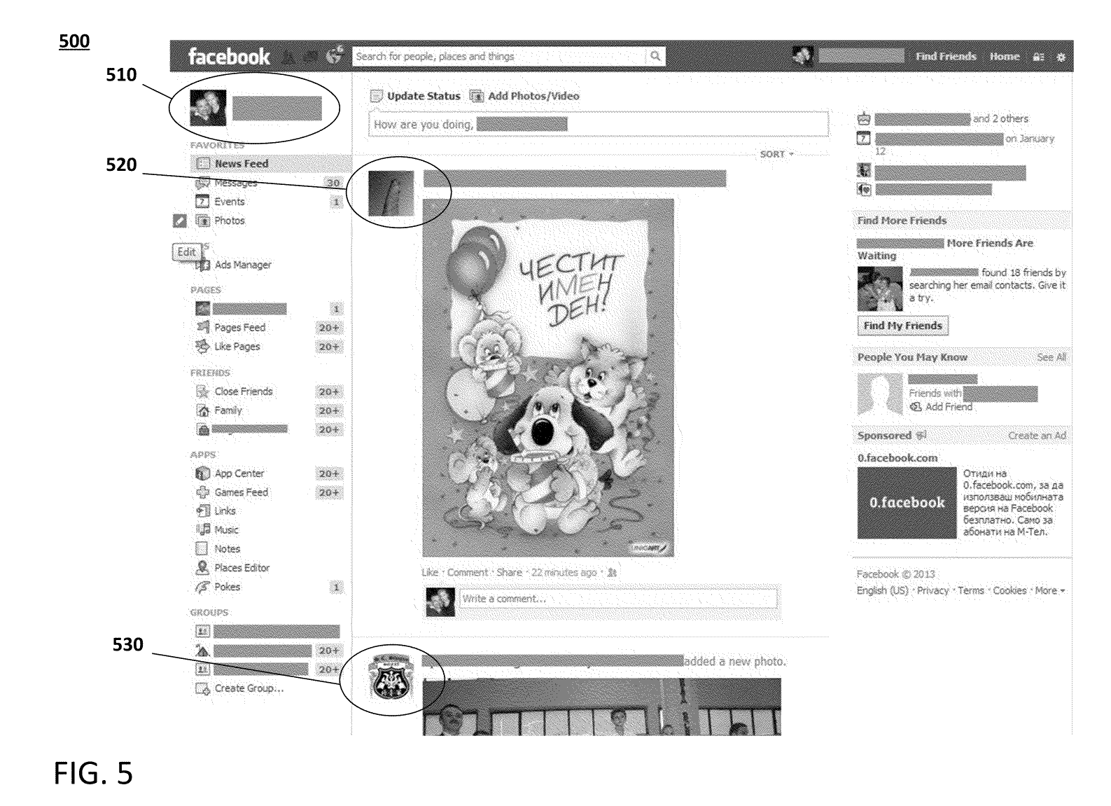

FIGS. 5-7 are screenshots of exemplary user interfaces of a prestige program that links the user's possessions associated with a financial institution with the user's status in the SNP.

FIG. 5 is a screenshot of an example user homepage 500 maintained in the SNP 120 and presented through the user interface 116. The circled material 510 shows a main user, while the circled materials 520 and 530 show two other users of the SNP.

FIG. 6 is a screenshot of an example user homepage 600 with the prestige program. The visualization of the prestige program can be achieved through comparing electronically stored information concerning the user's possessions and the electronically stored prestige status plan. If the comparison shows that the determined possession information qualifies for a prestige status of the prestige status plan, the prestige status of the user can be stored, by the one or more processors of the financial platform, in the database. The prestige status can be communicated to the social network platform for subsequent display of the prestige status. The circled materials 610 and 620 are two example hyperlinked graphic and text visualizations. The circled materials 610 and 620 can link to, for example, an information page of the prestige program. The circled material 630 is a graphic visualization of the avatar/name of a user that is a member of the prestige program with raised status, while the circled material 650 shows a user that does not participate in the prestige program. Upon hovering a mouse pointer over the visualization 630 of the user with raised status, a pop-up window 640 appears containing detailed text information about his status and the prestige program. In the illustrated example, users who participate in the prestige program can be a member of “Privilege Club.” The text information in the pop-up window 640 indicates to other users that the particular user is a member of the “Privilege Club.”

FIG. 7 is a screenshot of an example information page 700 of the prestige program. The example information page 700 can be a part of the user interface of the prestige program. In some instances, the example information page 700 is directed by the hyperlinked visualization 610 or 620. In the illustrated example, the information page 700 shows the instructions of the prestige program. Users in the prestige program with raised status may have access to separate SNP enhanced interface, e.g., “Privilege Club Lounge,” which can include all the functionalities of the standard interface but can include additional functions available only to users with raised status. The instructions on the information page 700 specify how to join the prestige program and obtain the raised status.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method for managing an electronic social network prestige program, the method comprising:
reading, by one or more processors of a financial platform, from a database a prestige status plan that includes a plurality of prestige statuses and criteria for each of the plurality of prestige statuses, at least one of the criteria indicating possessions required to qualify for the respective prestige status;
determining, by the one or more processors of the financial platform, possession information of a user of a social network platform by receiving at least some of the possession information from one or more financial institutions that are partnered with the social network platform, the social network platform being a third party to the financial platform and the one or more financial institutions;
comparing, by the one or more processors of the financial platform, the determined possession information with criteria of the prestige status plan;
if the comparison shows that the determined possession information qualifies for a prestige status of the prestige status plan,
storing, by the one or more processors of the financial platform, in the database the prestige status of the user; and
communicating, by the one or more processors of the financial platform, the prestige status to the social network platform for subsequent display of the prestige status, the prestige status being represented by a visualization that is displayed via a user interface and is visible to other users of the social network platform.

2. The method of claim 1, wherein the one or more financial institutions comprise one or more of a bank, a charity organization, a manufacturer, a merchant, or a service provider.

3. The method of claim 1, wherein determining possession information of the user of the social network platform comprises:
communicating a request to one of the financial institutions, and
receiving possession information from the financial institution.

4. The method of claim 1, further comprising communicating, to the social network platform, instructions for subsequent display of the instructions to the user of the social network platform via the user interface, wherein the instructions specify how to make transactions with the one or more financial institutions to qualify for the criteria of the prestige plan.

5. The method of claim 1, further comprising:
receiving a transaction request of the user;
communicating the transaction request to one of the financial institutions;
receiving, from the financial institution, a confirmation of the transaction; and
wherein determining the possession information of the user comprises determining the possession information of the user after the transaction.

6. The method of claim 1, further comprising:
if the user is not an existing client of the one of the financial institutions,
reading the user's information from a database of the social network platform; and
opening a new account for the user with one of the financial institutions using the user's information.

7. The method of claim 1, wherein the at least one of the criteria indicates required possessions at a single financial institution to qualify for the respective prestige status and the single financial institution is an exclusive regional partner of the social network platform; and wherein determining possession information of the user comprises determining possession information of the user at the single financial institution.

8. The method of claim 1, wherein the qualified prestige status is the highest prestige status that the determined possession information qualifies for.

9. The method of claim 1, wherein the qualified prestige status is a new prestige status;
wherein storing, in the database, the prestige status of the user comprises updating, in the database, the prestige status of the user to the new prestige status; and
wherein communicating the prestige status to the social network platform for subsequent display of the prestige status comprises communicating the new prestige status to the social network platform for subsequent display of the new prestige status, the new prestige status being represented by an updated visualization reflecting the new prestige status.

10. The method of claim 1, further comprising performing authentication of the user.

11. The method of claim 1, further comprising:
reading, from a database, a unique ID code identifying information of the user of the social network prestige program; and
communicating the unique ID code of the user to the social network platform.

12. The method of claim 1, wherein communicating the prestige status to the social network platform enables the user to design, modify, or delete the visualization of the prestige status.

13. The method of claim 1, wherein the prestige status is a first prestige status and the visualization is a first visualization, the method further comprising if the comparison shows that the determined possession information qualifies for a second prestige status of the prestige status plan,
storing, by the one or more processors of the financial platform, in the database, the second prestige status of the user; and
communicating, by the one or more processors of the financial platform, the second prestige status to the social network platform for subsequent display of the first prestige status and the second prestige status at the same time, the second prestige status being represented by a second visualization that is displayed via the user interface and is visible to other users of the social network platform.

14. The method of claim 1, further comprising, in response to determining the qualified prestige status of the user, providing the user access to privileged products or services including money-can't-buy events.

15. A computer program product encoded on a tangible, non-transitory storage medium, the product comprising computer readable instructions that, when executed by one or more processors of a financial platform, cause the one or more processors of the financial platform to perform operations for managing an electronic social network prestige program, the operations comprising:
reading, by the one or more processors of the financial platform, from a database, a prestige status plan that includes a plurality of prestige statuses and criteria for each of the plurality of prestige statuses, at least one of the criteria indicating possessions required to qualify for the respective prestige status;
determining, by the one or more processors of the financial platform, possession information of a user of a social network platform by receiving at least some of the possession information of the user from one or more financial institutions that are partnered with the social network platform, the social network platform being a third party to the financial platform and the one or more financial institutions;
comparing, by the one or more processors of the financial platform, the determined possession information with criteria of the prestige status plan;
if the comparison shows that the determined possession information qualifies for a prestige status of the prestige status plan,
storing, by the one or more processors of the financial platform, in the database, the prestige status of the user; and
communicating, by the one or more processors of the financial platform, the prestige status to the social network platform for subsequent display of the prestige status, the prestige status being represented by a visualization that is displayed via a user interface and is visible to other users of the social network platform.

16. The computer program product of claim 15, wherein the one or more financial institutions comprise one or more of a bank, a charity organization, a manufacturer, a merchant, or a service provider.

17. The computer program product of claim 15, wherein determining possession information of the user of the social network platform comprises:
communicating a request to one of the financial institutions, and
receiving possession information from the financial institution.

18. The computer program product of claim 15, the operations further comprising communicating, to the social network platform, instructions for subsequent display of the instructions to the user of the social network platform via the user interface, wherein the instructions specify how to make transactions with the one or more financial institutions to qualify for the criteria of the prestige plan.

19. The computer program product of claim 15, the operations further comprising:
receiving a transaction request of the user;
communicating the transaction request to one of the financial institutions;
receiving, from the financial institution, a confirmation of the transaction; and
wherein determining the possession information of the user comprises determining the possession information of the user after the transaction.

20. The computer program product of claim 15, the operations further comprising:
if the user is not an existing client of the one of the financial institutions,
reading the user's information from a database of the social network platform; and
opening a new account for the user with one of the financial institutions using the user's information.

21. The computer program product of claim 15, wherein the at least one of the criteria indicates required possessions at a single financial institution to qualify for the respective prestige status and the single financial institution is an exclusive regional partner of the social network platform; and wherein determining possession information of the user comprises determining possession information of the user at the single financial institution.

22. The computer program product of claim 15, wherein the qualified prestige status is the highest prestige status that the determined possession information qualifies for.

23. The computer program product of claim 15, wherein the qualified prestige status is a new prestige status;
wherein storing, in the database, the prestige status of the user comprises updating, in the database, the prestige status of the user to the new prestige status; and
wherein communicating the prestige status to the social network platform for subsequent display of the prestige status comprises communicating the new prestige status to the social network platform for subsequent display of the new prestige status, the new prestige status being represented by an updated visualization reflecting the new prestige status.

24. The computer program product of claim 15, the operations further comprising performing authentication of the user.

25. The computer program product of claim 15, the operations further comprising:
reading, from a database, a unique ID code identifying information of the user of the social network prestige program; and
communicating the unique ID code of the user to the social network platform.

26. The computer program product of claim 15, wherein communicating the prestige status to the social network platform enables the user to design, modify, or delete the visualization of the prestige status.

27. The computer program product of claim 15, wherein the prestige status is a first prestige status and the visualization is a first visualization, the operations further comprising if the comparison shows that the determined possession information qualifies for a second prestige status of the prestige status plan,
storing, by the one or more processors of the financial platform, in the database, the second prestige status of the user; and
communicating, by the one or more processors of the financial platform, the second prestige status to the social network platform for subsequent display of the first prestige status and the second prestige status at the same time, the second prestige status being represented by a second visualization that is displayed via the user interface and is visible to other users of the social network platform.

28. The computer program product of claim 15, the operations further comprising, in response to determining the qualified prestige status of the user, providing the user access to privileged products or services including money-can't-buy events.
